(19) United States
(12) Patent Application Publication
(10) Pub. No.: US 2022/0268082 A1
(43) Pub. Date: Aug. 25, 2022

(54) POWER WINDOW DEVICE

(71) Applicants: Atsushi FUJITA, Aichi (JP); Katsunori KIGOSHI, Aichi (JP); So FUJIOKA, Aichi (JP); Tatsuki NAGATA, Aichi (JP); Yuki YAMAMOTO, Aichi (JP); Masahiko HARA, Aichi (JP)

(72) Inventors: Atsushi FUJITA, Aichi (JP); Katsunori KIGOSHI, Aichi (JP); So FUJIOKA, Aichi (JP); Tatsuki NAGATA, Aichi (JP); Yuki YAMAMOTO, Aichi (JP); Masahiko HARA, Aichi (JP)

(73) Assignee: NIDEC MOBILITY CORPORATION, Aichi (JP)

(21) Appl. No.: 17/668,389

(22) Filed: Feb. 10, 2022

(30) Foreign Application Priority Data
Feb. 19, 2021 (JP) 2021-025138

(51) Int. Cl. E05F 15/72; E05F 15/695

(52) U.S. Cl. CPC E05F 15/72; E05F 15/695; E05Y 2201/434; E05Y 2400/40; E05Y 2400/52; E05Y 2800/252; E05Y 2900/55

(57) ABSTRACT

A power window device includes a control unit configured to monitor a first potential at one end of a first circuit including first and second switches turned on by manual opening and closing operations for a window, respectively, and a second potential at one end of a second circuit including a third switch turned on by an automatic opening or closing operation. The control unit is configured to output a manual window opening signal to a motor drive unit when the first potential is a potential at a time of the first switch being turned on; output a manual window closing signal when the first potential is a potential at a time of the second switch being turned on; and output an automatic window opening or closing signal when the second potential is a potential at a time of the third switch being turned on.

### CROSS-REFERENCE TO RELATED APPLICATIONS

This application is based upon and claims the benefit of priority from Japanese Patent Application No. 2021-025138, filed on Feb. 19, 2021, the entire contents of which are incorporated herein by reference.

### FIELD

One or more embodiments of the present invention relate to a power window device that opens and closes a window by a motor, and more particularly to a circuit configuration suitable for a power window device having a submersion detection function.

### BACKGROUND

A power window device mounted on a vehicle is a device that rotates a motor forward or reversely according to an operation state of a switch, and opens and closes a window via an opening/closing mechanism provided between the motor and the window. When the switch is operated to an UP (window closing) side, the motor rotates forward to close the window, and when the switch is operated to a DOWN (window opening) side, the motor rotates reversely to open the window. The forward and reverse rotation of the motor is controlled by switching a direction of a current flowing through the motor.

Even in a case where the vehicle is submerged and the window opening/closing control cannot be performed normally, the power window device has a function that can detect submersion, and forcibly open the window by an operation of a switch to enable escape from the window and ensure the safety of an occupant. In JP-A-2018-100507, JP-B2-6634351. JP-A-2018-135726, JP-A-2019-015115, and JP-A-2020-087834, a power window device with such a submersion detection function is described.

In the power window device described in JP-A-2018-100507, JP-B2-6634351. JP-A-2018-135726, and JP-A-2019-015115, a detection pad (electrode) for detecting submersion is provided so that the number of components increases and the circuit configuration becomes complicated. On the other hand, in the power window device described in JP-A-2020-087834, based on a comparison result between a voltage of a terminal and a predetermined threshold value when a constant current passes through an input terminal, a submerged state is determined without providing the detection pad. According to the power window device of JP-A-2020-087834, the detection pad is unnecessary and the constant current circuit is required, so that a circuit configuration is inevitably complicated.

In addition, when the window is closed by an erroneous switch operation when the vehicle is submerged, the window is closed and the occupant is difficult to escape, thereby threatening the safety of the occupant. Therefore, measures for that are also required. For example, in JP-A-2018-100507, there is provided a first switching element that turns on when the detection pad is short-circuited when the vehicle is submerged, and a second switching element that turns on when the first switching element turns on. When submersion is detected and each switching element turns on. one end of the window closing switch on a power supply side is grounded by the second switching element. Therefore, even if the window closing switch is operated, no current flows through the switch and the switch operation is not detected, so that it is possible to prevent the window from being erroneously closed when the vehicle is submerged. However, in order to realize this function, a switching element such as a transistor or a relay is required in addition to the detection pad, so that the circuit configuration becomes more complicated.

### SUMMARY

An object of one or more embodiments of the invention is to provide a power window device having a simplified circuit configuration by minimizing the number of components while maintaining a necessary function.

A power window device according to one or more embodiments of the present invention includes: an operation unit that is provided with a first switch that is turned on by a manual opening operation for a window, a second switch that is turned on by a manual closing operation for the window, and a third switch that is turned on by an automatic opening or closing operation for the window; a motor drive unit that drives a motor to open and close the window; and a control unit that controls an operation of the motor drive unit based on a state of each switch of the operation unit. The operation unit includes a first circuit including the first switch, the second switch, and a resistor, and a second circuit including the third switch. In the first circuit, a series circuit of the resistor and one of the first switch and the second switch is connected between a first power supply and a ground, and the other of the first switch and the second switch is connected in parallel with the series circuit. Further, in the second circuit, the third switch is connected between a second power supply and the ground. The control unit is configured to monitor each of a first potential at one end of the first circuit on a first power supply side and a second potential at one end of the second circuit on a second power supply side. The control unit is configured to output a manual window opening signal to the motor drive unit when the first potential is a potential at a time of the first switch being turned on, the manual window opening signal giving an instruction to open the window only during a turning on period of the first switch. The control unit is configured to output a manual window closing signal to the motor drive unit when the first potential is a potential at a time of the second switch being turned on, the manual window closing signal giving an instruction to close the window only during a turning on period of the second switch. On the other hand, the control unit is configured to output an automatic window opening signal or an automatic window closing signal to the motor drive unit when the second potential is a potential at a time of the third switch being turned on, the automatic window opening signal giving an instruction to continuously open the window to a fully opened position, the automatic window closing signal giving an instruction to continuously close the window to a fully closed position.

Therefore, the first potential at one end of the first circuit and the second potential at one end of the second circuit are changed by turning on of the first to third switches, and depending on the result, the signal for manually or automatically opening and closing the window is output from the control unit to the motor drive unit. For this reason, it is possible to significantly reduce the cost with the minimum number of components while maintaining functions necessary for the power window device by an extremely simple circuit configuration in which only one resistor is added to the existing switches in the operation unit.

In one or more embodiments of the present invention, the control unit may output the automatic window opening signal when the second potential is the potential at the time of the third switch being turned on and the first potential is the potential at the time of the first switch being turned on, and output the automatic window closing signal when the second potential is the potential at the time of the third switch being turned on and the first potential is the potential at the time of the second switch being turned on.

In one or more embodiments of the present invention, the power window device may have a submersion detection function. In this case, the control unit is configured to determine that submersion has occurred when the first potential is in a predetermined first submersion potential range, or when the second potential is in a predetermined second submersion potential range. At a normal time when there is no submersion, the control unit outputs the manual window opening signal when the first potential is the potential at the time of the first switch being turned on. and outputs the manual window closing signal when the first potential is the potential at the time of the second switch being turned on. On the other hand, at a time of submersion when there is submersion, the control unit outputs the manual window opening signal when the first potential is the potential at the time of the first switch being turned on, and does not output the manual window closing signal even when the first potential is the potential at the time of the second switch being turned on.

Further, the control unit may output the automatic window opening signal when the second potential at the normal time is the potential at the time of the third switch being turned on and when the first potential at the normal time is the potential at the time of the first switch being turned on, and output the automatic window closing signal when the second potential at the normal time is the potential at the time of the third switch being turned on and the first potential at the normal time is the potential at the time of the second switch being turned on.

Further, at the time of submersion, the control unit may not perform a determination of turning on of the second switch and turning on of the third switch, and perform only a determination of turning on of the first switch.

Further, with respect to the first potential at the normal time, a first submersion threshold value for determining presence or absence of submersion, a first on threshold value for determining the turning on of the first switch, and a second on threshold value for determining the turning on of the second switch may be set in the control unit, and with respect to the second potential at the normal time, a second submersion threshold value for determining presence or absence of submersion, and a third on threshold value for determining the turning on of the third switch may be set in the control unit. Further, with respect to the first potential at the time of submersion, a fourth submersion threshold value for determining the turning on of the first switch, and a first non-submersion threshold value for determining transition from a submerged state to a non-submerged state may be set in the control unit, and with respect to the second potential at the time of submersion, a second non-submersion threshold value for determining the transition from the submerged state to the non-submerged state may be set in the control unit. In the above case, the first submersion potential range is a range between the first submersion threshold value and the first on threshold value or the second on threshold value. and the second submersion potential range is a range between the second submersion threshold value and the third on threshold value.

In one or more embodiments of the present invention, the first switch may be a manual opening switch that is turned on by the manual opening operation for the window, the second switch may be a manual closing switch that is turned on by the manual closing operation for the window, and the third switch may include an auto-opening switch that is turned on by the automatic opening operation for the window continuously performed under a state where the first switch is turned on by the manual opening operation for the window, and an auto-closing switch that is turned on by the automatic closing operation for the window continuously performed under a state where the second switch is turned on by the manual closing operation for the window.

In one or more embodiments of the present invention, the operation unit may include a first terminal to which the one end of the first circuit is connected and a second terminal to which the one end of the second circuit is connected, and the control unit may include a third terminal connected to the first terminal by a first wiring and a fourth terminal connected to the second terminal by a second wiring. Further, the third terminal may be connected to the first power supply via a first pull-up resistor, and the fourth terminal may be connected to the second power supply via a second pull-up resistor. In this case, the control unit may monitor a potential at the third terminal as the first potential and monitor a potential at the fourth terminal as the second potential.

According to one or more embodiments of the present invention, it is possible to realize a power window device having a simplified circuit configuration with the minimum number of components while maintaining the necessary functions.

### BRIEF DESCRIPTION OF DRAWINGS

FIG. 1 is a circuit diagram illustrating a first embodiment of the present invention;

FIG. 2 is a diagram for explaining a determination threshold value used in a normal time;

FIG. 3 is a diagram for explaining a determination threshold value used at a time of submersion;

FIG. 4 is a diagram illustrating a potential change in a case where a manual opening operation is performed at a normal time;

FIG. 5 is a diagram illustrating a potential change in a case where a manual opening operation is performed at a time of submersion;

FIG. 6 is a diagram illustrating a potential change in a case where an auto-opening operation is performed at the normal time;

FIG. 7 is a diagram illustrating a potential change in a case where an auto-opening operation is performed at the time of submersion;

FIG. 8 is a diagram illustrating a potential change in a case where a manual closing operation is performed at the normal time;

FIG. 9 is a diagram illustrating a potential change in a case where a manual closing operation is performed at the time of submersion;

FIG. 10 is a diagram illustrating a potential change in a case where the auto-closing operation is performed at the normal time;

FIG. 11 is a diagram illustrating a potential change in a case where an auto-closing operation is performed at the time of submersion;

FIG. 12 is a circuit diagram illustrating a second embodiment of the present invention;

FIG. 13 is a circuit diagram illustrating a third embodiment of the present invention; and

FIG. 14 is a circuit diagram illustrating a fourth embodiment of the present invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

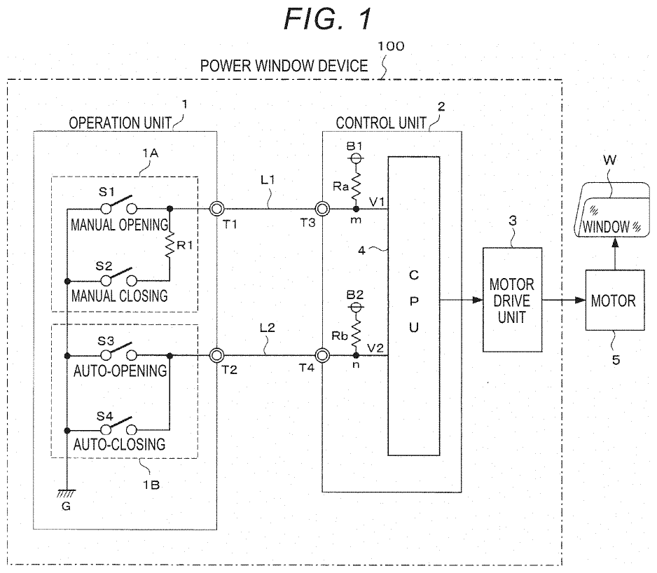

Embodiments of the present invention will be described with reference to the drawings. In the drawings, the same parts or corresponding parts are designated by the same reference numerals. FIG. 1 illustrates a power window device according to a first embodiment. A power window device 100 includes an operation unit 1, a control unit 2, and a motor drive unit 3.

The operation unit 1 is provided with a first circuit 1A, a second circuit 1B, a terminal T1 (first terminal), and a terminal T2 (second terminal). One end of the first circuit 1A is connected to the terminal T1, and the other end of the first circuit 1A is connected to a ground G. Further, one end of the second circuit 1B is connected to the terminal T2, and the other end of the second circuit 1B is connected to the ground G.

The control unit 2 is provided with a CPU 4, a pull-up resistor Ra (first pull-up resistor), a pull-up resistor Rb (second pull-up resistor), a terminal T3 (third terminal), and a terminal T4 (fourth terminal). One end of the pull-up resistor Ra is connected to a power supply B1 (first power supply), and the other end of the pull-up resistor Ra is connected to the terminal T3. One end of the pull-up resistor Rb is connected to the power supply B2 (second power supply), and the other end of the pull-up resistor Rb is connected to the terminal T4. Although the power supply B1 and the power supply B2 are distinguished here, they may be the same power supply. Hereinafter, a voltage of the power supply B1 is referred to as B1 for convenience, and a voltage of the power supply B2 is referred to as B2 for convenience.

The terminal T1 of the operation unit 1 is connected to the terminal T3 of the control unit 2 by a wiring L1 (first wiring). Further, the terminal T2 of the operation unit 1 is connected to the terminal T4 of the control unit 2 by a wiring L2 (second wiring).

In the operation unit 1, the first circuit 1A has a switch S1, a switch S2, and a resistor R1. The switch S1 is a manual opening switch for manually opening the window, and the switch S2 is a manual closing switch for manually closing the window. The resistor R1 is connected in series with the manual closing switch S2, and the manual opening switch S1 is connected in parallel with this series circuit.

The second circuit 1B has a switch S3 and a switch S4. The switch S3 is an auto-opening switch for automatically opening the window. The switch S4 is an auto-closing switch for automatically closing the window. These switches S3 and S4 are connected in parallel.

The resistance values of the pull-up resistor Ra and the pull-up resistor Rb may be the same or different. Further, the resistance values of the resistor R1 and the pull-up resistor Ra may be the same or different.

The manual opening switch S1 corresponds to the “first switch” in one or more embodiments of the present invention, and the manual closing switch S2 corresponds to the “second switch” in one or more embodiments of the present invention. Further, the auto-opening switch S3 and the auto-closing switch S4 correspond to the “third switch” in one or more embodiments of the present invention.

The manual opening switch S1 and the auto-opening switch S3 are mechanically configured to be operated by a common operation knob (not illustrated). Specifically, when the operation knob is pushed down, the manual opening switch S1 is first turned on (in a state where a contact point is closed), and the manual opening operation is performed. When the operation knob is further pushed down from this state, the auto-opening switch S3 is turned on in addition to the manual opening switch S1, and the operation shifts to the auto-opening operation. That is, the auto-opening switch S3 is turned on by the automatic opening operation for the window W continuously in a state where the manual opening switch S1 is turned on by the manual opening operation for the window W.

In the manual opening operation, the window W is opened only while the pushing-down of the operation knob is held (period during which the manual opening switch S1 is turned on), and when the pushing-down is released, the opening operation for the window W is stopped. On the other hand, in the auto-opening operation, the window W continues to open to the fully opened position even if the pushing-down of the operation knob is released.

Similarly, the manual closing switch S2 and the auto-closing switch S4 are also mechanically configured to be operated by the above-mentioned common operation knob. Specifically, when the operation knob is pulled up, the manual closing switch S2 is first turned on, and the manual closing operation is performed. When the operation knob is further pulled up from this state, the auto-closing switch S4 is turned on in addition to the manual closing switch S2, and the operation shifts to the auto-closing operation. That is, the auto-closing switch S4 is turned on by the operation of automatically closing the window W continuously in a state where the manual closing switch S2 is turned on by the operation of manually closing the window W.

In the manual closing operation, the window W is closed only while the pulling-up of the operation knob is held (period during which the manual closing switch S2 is turned on), and when the pulling-up is released, the closing operation for the window W is stopped. On the other hand, in the auto-closing operation, the window W is continuously closed to the fully closed position even if the pulling-up of the operation knob is released.

In the first circuit 1A, the manual opening switch S1 is connected between the terminal T1 and the ground G. Further, the series circuit of the manual closing switch S2 and the resistor R1 is connected between the terminal T1 and the ground G. The terminal T1 is connected to the power supply B1 via the wiring L1, the terminal T3, and the pull-up resistor Ra.

In the second circuit 1B, the auto-opening switch S3 is connected between the terminal T2 and the ground G. Further, the auto-closing switch S4 is connected between the terminal T2 and the ground G. The terminal T2 is connected to the power supply B2 via the wiring L2, the terminal T4, and the pull-up resistor Rb.

In the control unit 2, the input side of the CPU 4 is connected to a connection point m between the pull-up resistor Ra and the terminal T3 and a connection point n between the pull-up resistor Rb and the terminal T4. The CPU 4 monitors a potential V1 (first potential) of the terminal T3 and a potential V2 (second potential) of the terminal T4, and controls the motor drive unit 3 based on a result thereof (details will be described later).

The motor drive unit 3 is configured of a known circuit including a PWM circuit that generates a pulse width modulation (PWM) signal, a switching circuit that performs a switching operation by the PWM signal, and the like.

In the present embodiment, the motor 5 is configured of a DC motor and rotates at a predetermined speed based on a drive voltage output from the motor drive unit 3. In the operation unit 1, when the window closing operation is performed and the manual closing switch S2 or the auto-closing switch S4 is turned on, a signal instructing the closing of the window W is output from the control unit 2 (CPU4), and based on this signal, the window W is closed. The motor 5 rotates forward and the window W closes based on this command signal. Further, in the operation unit 1, when the window opening operation is performed and the manual opening switch S1 or the auto-opening switch S3 is turned on, a signal instructing the opening of the window W is output from the control unit 2 (CPU4) and the motor 5 rotates reversely and the window W opens based on this command signal. An opening/closing mechanism (not illustrated) is provided between the motor 5 and the window W.

Although not illustrated in FIG. 1, the control unit 2 performs feedback control for the motor drive unit 3 such that the rotation speed of the motor 5 is set as a target speed based on an output of a sensor (rotary encoder or the like) that detects the rotation speed of the motor 5.

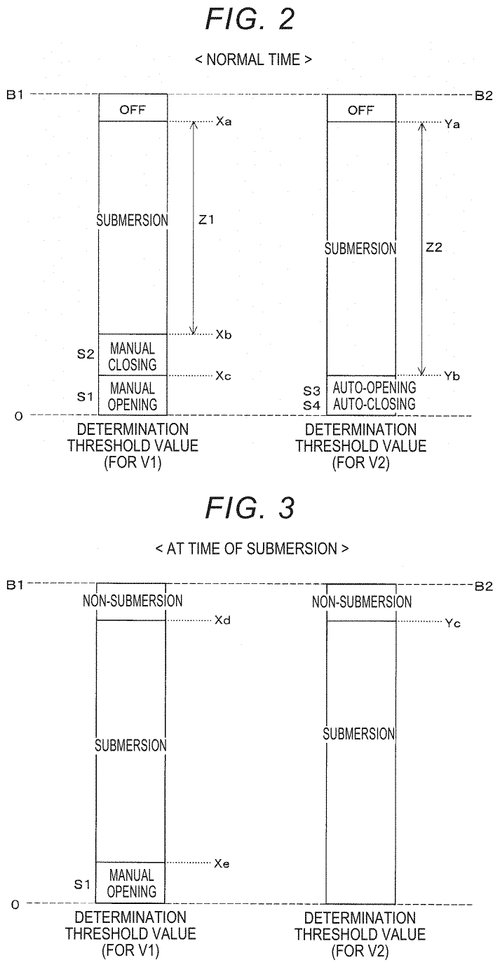

Next, each operation of the power window device 100 of FIG. 1 at the normal time and at the time of submersion will be described in detail with reference to FIGS. 2 to 11.

As described above, the CPU 4 of the control unit 2 monitors the potential V1 of the terminal T3 and the potential V2 of the terminal T4. Since the terminals T3 and T4 are connected to the terminals T1 and T2, respectively, the potential V1 is a potential at one end of the first circuit 1A on a power supply B1 side, and the potential V2 is a potential at one end of the second circuit 1B on a power supply B2 side. With respect to these potentials V1 and V2, a threshold value for determining the turning-on of the switches S1 to S4 and a threshold value for determining the presence or absence of submersion are set in the control unit 2. Each threshold value is stored in advance in an internal memory (not illustrated) built in the CPU 4 or an external memory (not illustrated) provided separately from the CPU 4.

FIG. 2 illustrates a determination threshold value used at the normal time when submersion does not occur. Here, three threshold values Xa, Xb, and Xc are set between the power supply voltage B1 and zero volt with respect to the potential V1, and two threshold values Ya and Yb are set between the power supply voltage B2 and zero volt with respect to the potential V2. The power supply voltages B1 and B2 have the same value.

Among the threshold values set for the potential V1, Xa is a submersion threshold value (first submersion threshold value) for determining the presence or absence of submersion. Xc is an on threshold value (first on threshold value) for determining that the manual opening switch S1 is turned on. Xb is an on threshold value (second on threshold value) for determining that the manual closing switch S2 is turned on. A region Z1 (Xa≥Z1>Xb) between Xa and Xb indicates a first submersion potential range.

The CPU 4 compares the potential V1 with each of the threshold values Xa to Xc, and determines that submersion has occurred in the power window device 100 if Xa≥V1>Xb (that is, if V1 is in the first submersion potential range Z1). Further, the CPU 4 determines that the manual closing switch S2 is turned on if Xb≥V1>Xc, and determines that the manual opening switch S1 is turned on if Xc≥V1≥0.

Further, among the threshold values set for the potential V2, Ya is a submersion threshold value (second submersion threshold value) for determining the presence or absence of submersion, and Yb is an on threshold value (third on threshold value) for determining that the auto-opening switch S3 or the auto-closing switch S4 is turned on. A region Z2 (Ya≥Z2>Yb) between Ya and Yb indicates a second submersion potential range. The submersion threshold value Ya is substantially the same as the submersion threshold value Xa (Ya≈Xa).

The CPU 4 compares the potential V2 with each of the threshold values Ya and Yb, and determines that submersion has occurred if Ya≥V2>Yb (that is, if V2 is in the second submersion potential range Z2). Further, if Yb≥V2≥0, the CPU 4 determines that the auto-opening switch S3 or the auto-closing switch S4 is turned on.

Which of the auto-opening switch S3 and the auto-closing switch S4 is turned on can be determined by referring to the comparison result between the potential V1 and the on threshold values Xb and Xc. As described above, in a case where the auto-opening switch S3 is turned on, the manual opening switch S1 is also in the on state, so that the potential V1 is in the range of Xc≥V1≥0. Therefore, in FIG. 2, if Yb≥V2≥0 and Xc≥V1≥0, the CPU 4 determines that the auto-opening switch S3 is turned on. Further, in a case where the auto-closing switch S4 is turned on. the manual closing switch S2 is also in the on state, so that the potential V1 is in the range of Xb≥V1>Xc. Therefore, in FIG. 2, if Yb≥V2≥0 and Xb≥V1>Xc, the CPU 4 determines that the auto-closing switch S4 is turned on.

FIG. 3 illustrates a determination threshold value used at the time of submersion in which the power window device 100 is in the submerged state. At the time of submersion, two threshold values Xd and Xe are set between the power supply voltage B1 and zero volt with respect to the potential V1. The threshold value Xd is anon-submersion threshold value (first non-submersion threshold value) for determining that the transition from the submerged state to the non-submerged state has occurred. The threshold value Xe is anon threshold value (fourth on threshold value) for determining that the manual opening switch S1 is turned on at the time of submersion. On the other hand, for the potential V2, only one threshold value Yc is set between the power supply voltage B2 and zero volt. This threshold value Yc is also a non-submersion threshold value (second non-submersion threshold value) similar to the threshold value Xd.

For each of the threshold values in FIGS. 2 and 3, Xa and Ya. Xb and Yb, Xd and Yc, Xa and Xd, Xc and Xe, and Ya and Yc may have the same value or different values.

At the normal time, the CPU 4 of the control unit 2 determines whether the switch is turned on and the presence or absence of submersion based on the comparison result between the potentials V1 and V2, and each threshold value of FIG. 2. Then, in a case where it is determined that submersion has occurred, the CPU 4 determines whether the switch is turned on and the presence or absence of submersion by using the determination threshold value of FIG. 3 instead of the determination threshold value of FIG. 2.

In FIG. 3, the potentials V1 and V2 are in the range of Xd≥V1>Xe and Yc≥V2≥0. respectively. while the submerged state continues. At this time, for the potential V1, the on threshold value Xe of the manual opening switch S1 is set, but the on threshold value of the manual closing switch S2 is not set. Therefore, the turning on of the manual closing switch S2 is not determined, and only the turning on of the manual opening switch S1 is determined. Further, for the potential V2, the on threshold value is not set for any of the switches S3 and S4, and the turning on of these switches S3 and S4 is not determined. Therefore, at the time of submersion, the CPU 4 performs only a determination of turning on of the manual opening switch S1 based on the potential V1 and the on threshold value Xe, and determines that the switch S1 is turned on when Xe≥V1≥0.

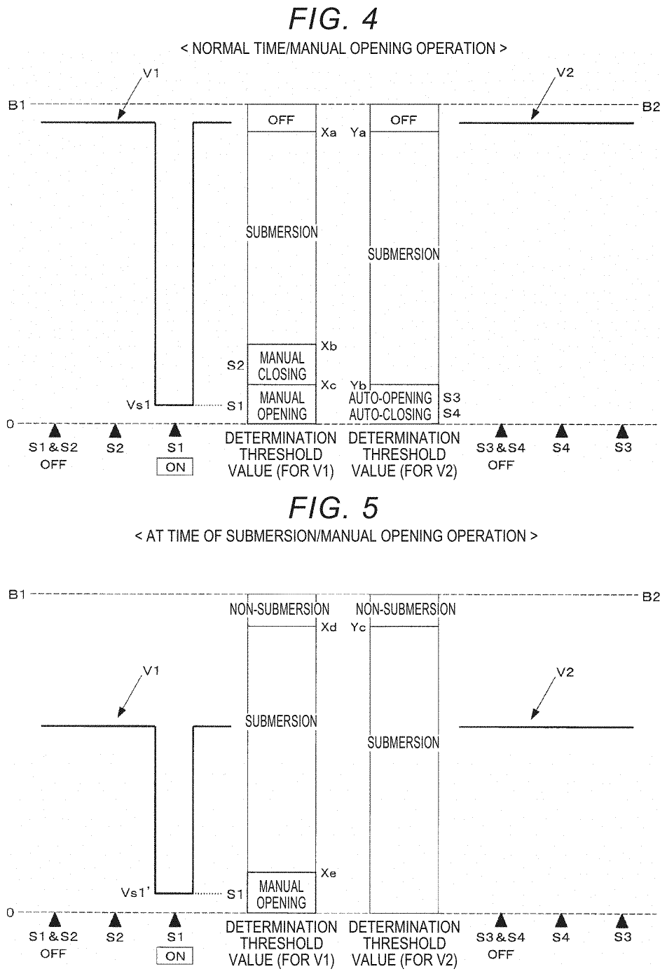

FIG. 4 illustrates a state of a change in the potentials V1 and V2 in a case where the “manual opening” operation is performed at the normal time when submersion does not occur. Since the potential V1 is the potential at the terminal T3, the potential V1 changes when the switches S1 and S2 connected to the terminal T3 are turned on, and the potential V1 does not change when the switches S3 and S4 which are not connected to the terminal T3 are turned on. On the other hand, since the potential V2 is the potential at the terminal T4, the potential V2 changes when the switches S3 and S4 connected to the terminal T4 are turned on, and the potential V2 does not change when the switches S1 and S2 which are not connected to the terminal T4 are turning on.

In FIG. 4, in a case where the switches S1 and S2 are both turned off, the potential V1 is in the range of B1≥V1>Xa (OFF region). In a case where both the switches S3 and S4 are turned off, the potential V2 is in the range of B2≥V2>Ya (OFF region).

Now, when the “manual opening” operation is performed and the manual opening switch S1 is turned on, the potential V1 drops to Vs1. From FIG. 1, Vs1 at this time is obtained as follows:

$$Vs 1 = B 1 \cdot Rw / ( Ra + Rw )$$

where a total value of the resistances in the switch S1 and the wiring L1 is Rw. Here, Rw is a value sufficiently smaller than Ra (Ra>>Rw). If this Vs1 is in the range of Xc≥Vs1≥0, the CPU 4 determines that the manual opening switch S1 is turned on, and outputs a manual window opening signal instructing the manual opening of the window W to the motor drive unit 3. Therefore, the window W is opened based on the manual opening operation.

FIG. 5 illustrates a state of a change in the potentials V1 and V2 in a case where the “manual opening” operation is performed at the time of submersion. The operation unit 1 and the control unit 2 illustrated in FIG. 1 have a waterproof structure in which water does not enter, and during in the submerged state, electric leakage occurs at the terminals T1 to T4 exposed to the outside, so that the potentials V1 and V2 before the operation of the switches S1 to S4 are lower than that at the normal time in FIG. 4 (same applies to FIGS. 7, 9, and 11).

In FIG. 5, in a case where both the switches S1 and S2 are turned off, the potential V1 is in the range of Xd≥V1>Xe (submerged state). In a case where both the switches S3 and S4 are turned off, the potential V2 is in the range of Yc≥V2≥0 (submerged state). In this state, when the “manual opening” operation is performed and the manual opening switch S1 is turned on, the potential V1 drops to Vs1′. At this time, Vs1′ is substantially the same value as Vs1 in FIG. 4, and is in the range of Xe≥Vs1′≥0. On the other hand, even if the manual opening switch S1 is turned on, the potential V2 does not change.

When Xe≥Vs1′≥0 in the submerged state, the CPU 4 determines that the manual opening switch S1 is turned on, and outputs the manual window opening signal instructing the manual opening of the window W to the motor drive unit 3. Therefore, at the time of submersion, the window W can be opened to escape from the vehicle by turning on the switch S1 by the “manual opening” operation.

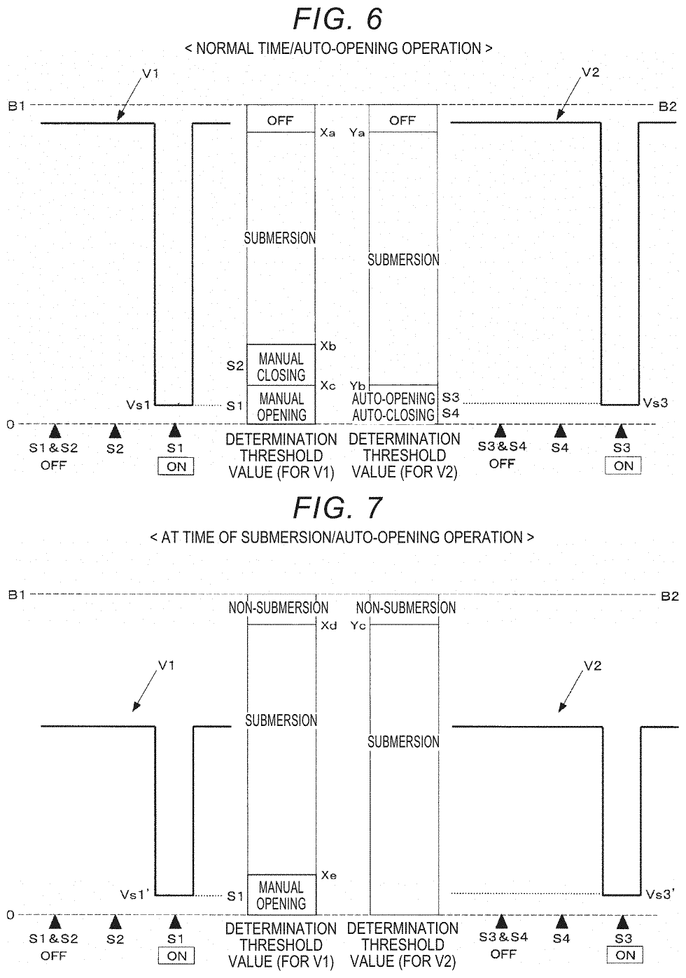

When the submerged state is released, electric leakage at the terminals T1 to T4 disappears, so that the current flowing through the first circuit 1A and the second circuit 1B increases and the potentials V1 and V2 rise, and in FIG. 5, B1≥V1>Xd or B2≥V2>Yc. At this time, the CPU 4 determines that the state has changed from the submerged state to the non-submerged state, and switches the determination threshold value in FIG. 3 to the determination threshold value in FIG. 2. Therefore, the processing is performed based on the above-mentioned determination threshold value at the normal time (the same applies to the following FIGS. 6 to 11).

FIG. 6 illustrates a state of a change in the potentials V1 and V2 in a case where the “auto-opening” operation is performed at the normal time. When the “auto-opening” operation is performed, both the manual opening switch S1 and the auto-opening switch S3 are in the turned on state. Since the potential Vs1 when the manual opening switch S1 is turned on is the same as in FIG. 4, the description thereof will be omitted. In FIG. 6, the potential V2 drops to Vs3 when the auto-opening switch S3 is turned on. From FIG. 1, Vs3 at this time is obtained as follows:

$$Vs 3 = B 2 \cdot Rx / ( Rb + Rx )$$

where the total value of the resistances is Rx in the switch S3, the wiring L2, and the like. Here, Rx is a value sufficiently smaller than Rb (Rb>>Rx). If Vs3 is in the range of Yb≥Vs3≥0 and Vs1 is in the range of Xc≥Vs1≥0, the CPU 4 determines that the auto-opening switch S3 is turned on and outputs the automatic window opening signal instructing the automatic opening of the window W to the motor drive unit 3. Therefore, the window W is opened based on the auto-opening operation.

FIG. 7 illustrates a state of a change in the potentials V1 and V2 in a case where the “auto-opening” operation is performed at the time of submersion. As can be seen from the drawing, when the switches S1 and S3 are turned on, the potential V1 drops to Vs1′ and the potential V2 drops to Vs3′. At this time, Vs1′ and Vs3′ have almost the same values as Vs1 and Vs3 in FIG. 6, respectively, but since the on threshold value is not set for Vs3′, the turning on of the auto-opening switch S3 is not determined even though the auto-opening operation is performed. However, since the on threshold value Xe is set for Vs1′, the CPU 4 determines that the manual opening switch S1 is turned on if Xe≥Vs1′≥0 as in the case of FIG. 5, and outputs the manual window opening signal instructing the manual opening of the window W to the motor drive unit 3. Therefore, at the time of submersion, the window W can be opened and escaped by performing the “auto-opening” operation.

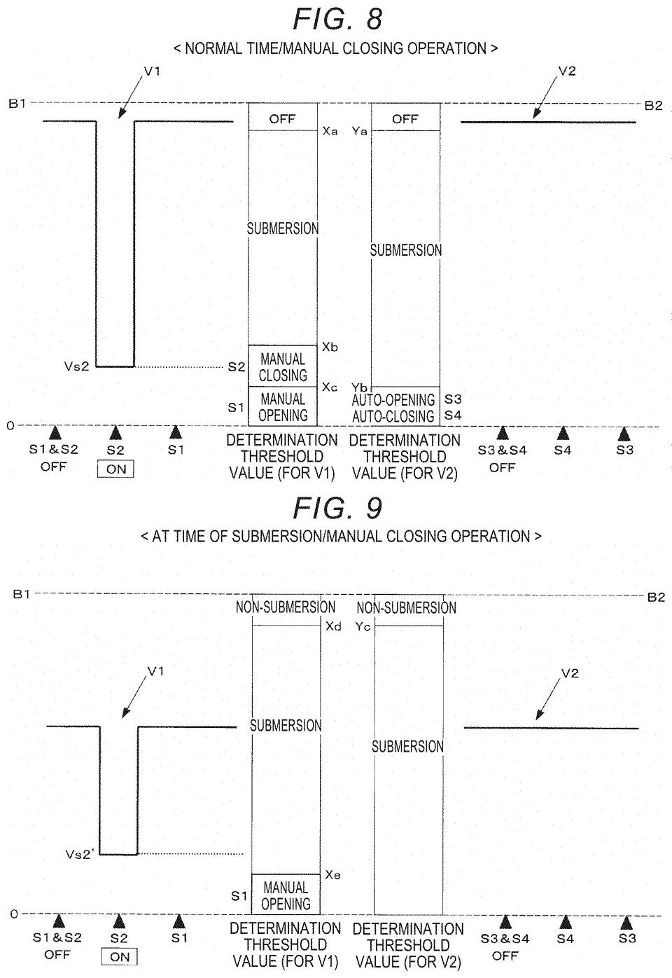

FIG. 8 illustrates a state of a change in the potentials V1 and V2 in a case where the “manual closing” operation is performed at the normal time. When the manual closing switch S2 is turned on by the “manual closing” operation, the potential V1 drops to Vs2. From FIG. 1, Vs2 at this time is obtained as follows:

$$Vs 2 = B 1 \cdot ( R 1 + Ry ) / ( Ra + R 1 + Ry )$$

where the total value of the resistances in the switch S2, the wiring L1, and the like is Ry. Here, Ry is a value sufficiently smaller than Ra and R1 (Ra>>Ry, and R1>>Ry). Further, since the resistor R1 is connected in series to the manual closing switch S2, the value of Vs2 is larger than that of Vs1 in FIG. 4 (Vs2>Vs1). If Vs2 is in the range of Xb≥Vs2>Xc, the CPU 4 determines that the manual closing switch S2 is turned on, and outputs the manual window closing signal instructing the manual closing of the window W to the motor drive unit 3. As a result, the window W is closed based on the manual closing operation.

FIG. 9 illustrates a state of a change in the potentials V1 and V2 in a case where the “manual closing” operation is performed at the time of submersion. As can be seen from the drawing, when the manual closing switch S2 is turned on, the potential V1 drops to Vs2′, but since the on threshold value is not set for this Vs2′, the turning on of the manual closing switch S2 is not determined even though the manual closing operation is performed. That is, since the “manual closing” operation is ignored in the submerged state, the manual window closing signal is not output from the CPU 4 to the motor drive unit 3 and the window W is not closed even if the operation is performed. Therefore, even if the “manual closing” operation is erroneously performed at the time of submersion, it is possible to avoid a situation in which the window W is closed and it is impossible to escape.

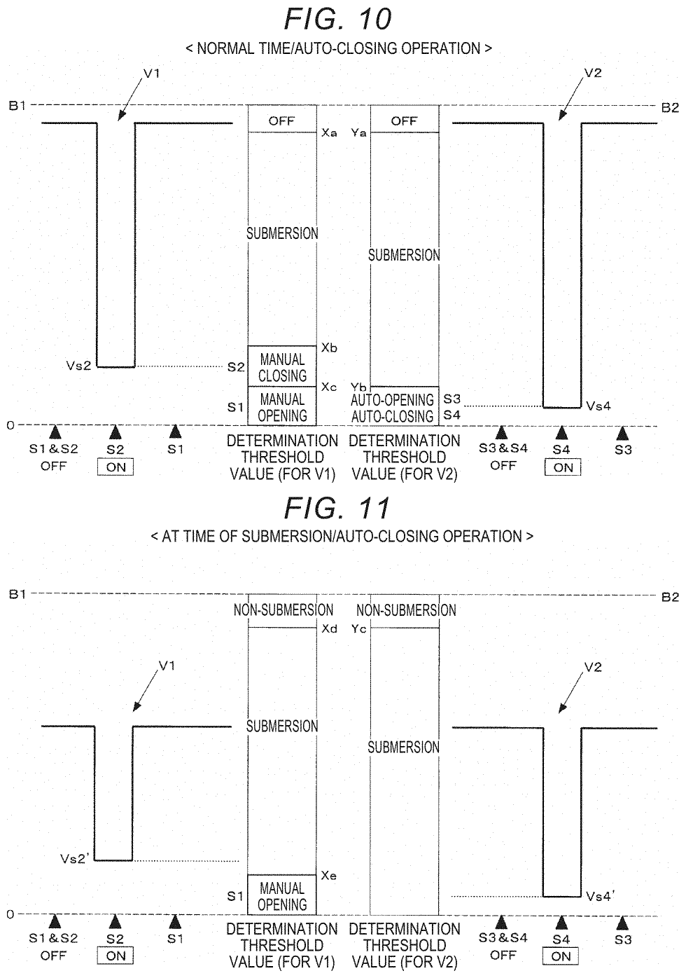

FIG. 10 illustrates a state of a change in the potentials V1 and V2 in a case where the “auto-closing” operation is performed at the normal time. When the “auto-closing” operation is performed, both the manual closing switch S2 and the auto-closing switch S4 are turned on. Since the potential Vs2 when the manual closing switch S2 is turned on is the same as in FIG. 8, the description thereof will be omitted. In FIG. 10, when the auto-closing switch S4 is turned on, the potential V2 drops to Vs4. From FIG. 1, Vs4 at this time is obtained as follows:

$$Vs 4 = B 2 \cdot Rz / ( Rb + Rz )$$

where the total value of the resistances in the switch S4, the wiring L2, and the like is Rz. Here, Rz is a value sufficiently smaller than Rb (Rb>>Rz). If Vs4 is in the range of Yb≥Vs4≥0 and the Vs2 is in the range of Xb≥Vs2>Xc, the CPU 4 determines that the auto-closing switch S4 is turned on and outputs the automatic window closing signal instructing the automatic closing of the window W to the motor drive unit 3. Therefore, the window W is closed based on the auto-closing operation.

FIG. 11 illustrates a state of a change in the potentials V1 and V2 in a case where the “auto-closing” operation is performed at the time of submersion. As can be seen from the drawing, when the switches S2 and S4 are turned on, the potential V1 drops to Vs2′ and the potential V2 drops to Vs4′. At this time, Vs2′ and Vs4′ have almost the same values as Vs2 and Vs4 in FIG. 10. respectively, but since the on threshold value is not set for Vs2′, the manual closing switch S2 is not determined as in the case of FIG. 9. Further, since the on threshold value is not set for Vs4′, the turning on of the auto-closing switch S4 is not determined even though the auto-closing operation is performed. That is, since the “auto-closing” operation is ignored in the submerged state, the automatic window closing signal is not output from the CPU 4 to the motor drive unit 3 and the window W is not closed even if the operation is performed. Therefore, even if the “auto-closing” operation is erroneously performed at the time of submersion, it is possible to avoid a situation in which the window W is closed and it is impossible to escape.

According to the first embodiment described above, the potentials V1 and V2 at each one end of the first circuit 1A and the second circuit 1B are monitored by the CPU 4, and in a case where the potential V1 is in the first submersion potential range Z1 or the potential V2 is in the second submersion potential range Z2, when the manual opening switch S1 or the auto-opening switch S3 is turned on, the manual window opening signal is output from the CPU 4 even in a case where any one of the switches is turned on. Therefore, by performing the “manual opening” operation or the “auto-opening” operation by the operation unit 1 at the time of submersion, the window W is opened and it is possible to escape from the inside of the vehicle.

On the other hand, in a case where the potential V1 is in the submersion potential range Z1 or the potential V2 is in the submersion potential range Z2, even if the manual closing switch S2 or the auto-closing switch S4 is turned on, the manual window closing signal and the automatic window closing signal are not output from the CPU 4. Therefore, even if the “manual closing” operation or the “auto-closing” operation is erroneously performed at the time of submersion, those operations are ignored and the window W is not closed, so that safety can be ensured.

Then, in order to realize the various functions as described above, in one or more embodiments of the present invention, only one resistor R1 is sufficient to be added to the existing switches S1 to S4 in the operation unit 1. Therefore, a detection pad for submersion as in JP-A-2018-100507, JP-B2-6634351. JP-A-2018-135726, and JP-A-2019-015115, a constant current circuit as in JP-A-2020-087834, and a switching element as in JP-A-2018-100507 are not necessary, and the circuit configuration becomes extremely simple. As a result, while significantly reducing the cost with the minimum number of components, it is possible to realize the power window device 100 having four functions of “manual opening”, “manual closing”, “auto-opening”, and “auto-closing”, a function of detecting submersion, and a function of permitting window opening and prohibiting window closing at the time of submersion.

Further, even in a case where one of the potentials V1 and V2 is not in the submersion potential ranges Z1 and Z2, if the other is in the submersion potential ranges Z1 and Z2, it is determined that submersion has occurred. Therefore, even if an electric leakage does not occur in the terminals T1 and T3, the potential V2 enters the submersion potential range Z2 if there is electric leakage at the terminals T2 and T4, so that it is possible to determine that submersion has occurred, and the reliability of submersion detection is improved. In addition, since submersion is detected by two systems of the first circuit 1A and the second circuit 1B, even if a malfunction such as failure, disconnection, or poor contact occurs in one circuit, submersion can be detected by the other circuit, and reliability is further improved. Furthermore, a power window device having a submersion detection function and a power window device without having a submersion detection function can be realized by a same circuit board assembly only by changing a software program of the CPU 4, so that the product numbers can be shared to facilitate management.

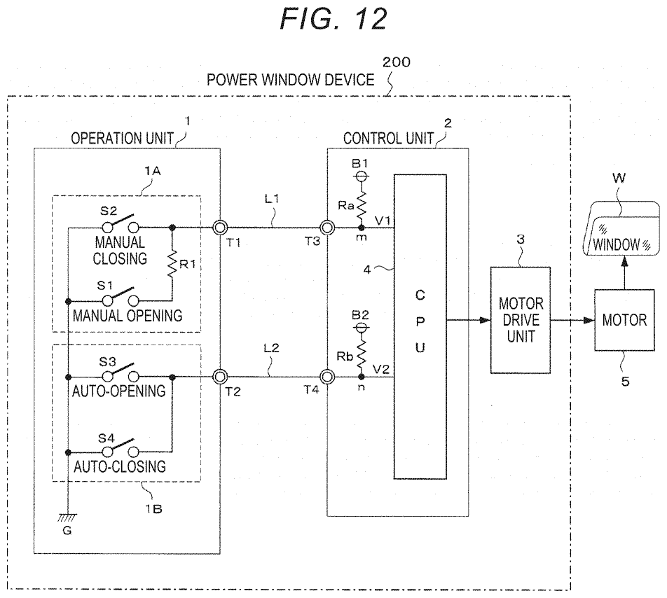

FIG. 12 illustrates a power window device 200 according to a second embodiment of the present invention. FIG. 12 is different from FIG. 1 in that in the first circuit 1A, the manual opening switch S1 and the resistor R1 are connected in series, and the manual closing switch S2 is connected in parallel with these series circuits. The configuration of the second circuit 1B is the same as that of FIG. 1, and the other configurations are also the same as those of FIG. 1.

That is, in the second embodiment, the manual opening switch S1 and the manual closing switch S2 are interchanged in the first circuit 1A of FIG. 1. In the second embodiment, in FIG. 2, Xb is the on threshold value for the manual opening switch S1 and Xc is the on threshold value for the manual closing switch S2.

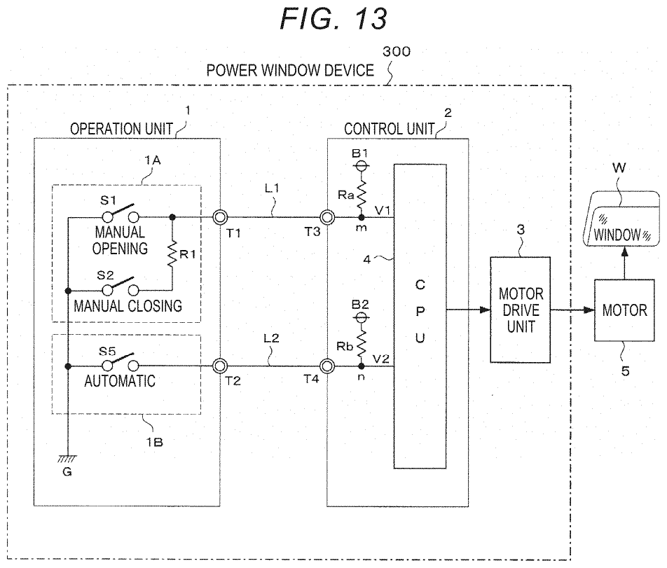

FIG. 13 illustrates a power window device 300 according to a third embodiment of the present invention. FIG. 13 differs from FIG. 1 in that the second circuit 1B is configured of only an automatic switch S5. The configuration of the first circuit 1A is the same as that of FIG. 1, and the other configurations are also the same as those of FIG. 1. The automatic switch S5 corresponds to the “third switch” of one or more embodiments of the present invention, and has the functions of both the auto-opening switch and the auto-closing switch. Specifically. after the manual opening switch S1 is turned on by the manual opening operation, the automatic switch S5 is turned on when the auto-opening operation is continuously performed. Further, after the manual closing switch S2 is turned on by the manual closing operation, the automatic switch S5 is turned on when the auto-closing operation is continuously performed. In the third embodiment, in FIG. 2, Yb is an on threshold value for the automatic switch S5.

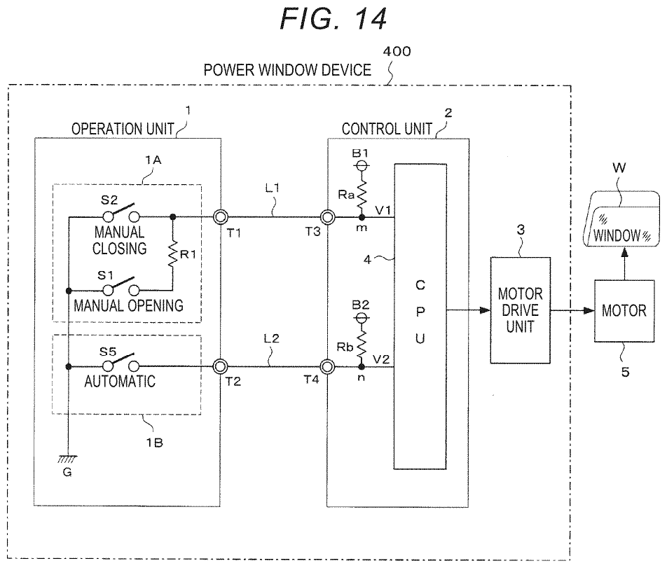

FIG. 14 illustrates a power window device 400 according to a fourth embodiment of the present invention. In FIG. 14, the manual opening switch S1 and the manual closing switch S2 in FIG. 13 are interchanged. The configuration of the second circuit 1B is the same as that of FIG. 13, and the other configurations are also the same as those of FIG. 13. In the fourth embodiment, in FIG. 2, Xb is the on threshold value for the manual opening switch S1, Xc is the on threshold value for the manual closing switch S2, and Yb is the on threshold value for the automatic switch S5.

The same effects as those of the first embodiment can be obtained by the second embodiment, the third embodiment, and the fourth embodiment.

In each of the above-described embodiments, the power window device provided with the submersion detection function is taken as an example, but one or more embodiments of the present invention can also be applied to a power window device that is not provided with the submersion detection function. As described above, the power window device without the submersion detection function can be realized only by changing the software program, and does not require the change of the hardware configuration.

For example, in a case where the power window device 100 illustrated in FIG. 1 does not have the submersion detection function, the circuit configurations of the operation unit 1, the control unit 2, and the motor drive unit 3 are the same as the circuit configuration in a case where the submersion detection function is provided, and only the software program of the CPU 4 is different. Even in the power window device 100 that does not have the submersion detection function, by configuring the operation unit 1 as in one or more embodiments of the present invention, it is possible to significantly reduce the cost with the minimum number of components while maintaining the necessary functions. This will be described in more detail below.

In the case of the power window device 100 having no submersion detection function, the on threshold values Xb, Xc, and Yb of FIG. 2 are set for the switches S1 to S4, while the submersion threshold values Xa and Ya are not set. As a matter of course, the threshold values Xd, Xe, and Yc at the time of submersion in FIG. 3 are not set. Further, the submersion potential ranges Z1 and Z2 in FIG. 2 are changed to the OFF region.

The on determination of the switches S1 to S4 is the same as the determination at the normal time (non-submerged state) in a case where there is the submersion detection function. Specifically, when the manual opening switch S1 is turned on by the “manual opening” operation, the potential V1 is Xc≥V1≥0, and when the manual closing switch S2 is turned on by the “manual closing” operation, the potential V1 is Xb≥V1>Xc, so that it is possible to determine that the switches S1 and S2 are turned on from the respective results.

Further, when the auto-opening switch S3 or the auto-closing switch S4 is turned on by the “auto-opening” operation or the “auto-closing” operation, the potential V2 is Yb≥V2≥0. At this time, as described above, if the potential V1 is Xc≥V1≥0, it is determined that the auto-opening switch S3 is turned on, and if the potential V1 is Xb≥V1>Xc, it is determined that the auto-closing switch S4 is turned on.

In this way, even in the power window device 100 having no submersion detection function, it is possible to significantly reduce the cost with the minimum number of components while maintaining four functions of “manual opening”, “manual closing”, “auto-opening”, and “auto-closing” by an extremely simple circuit configuration in which only one resistor R1 is added to the existing switches S1 to S4.

In the present invention, various embodiments can be adopted in addition to the above-described embodiments.

For example, in the above-described embodiments, an example is given in which the motor 5 is provided outside the power window device 100, 200, 300, and 400, but the motor 5 may be provided in the power window device. The power window device in this case can be configured as a motor module in which the operation unit 1, the control unit 2, the motor drive unit 3. and the motor 5 are mounted on the circuit board.

For example, in the above-described embodiments, an example is given in which the pull-up resistors Ra and Rb are provided in the control unit 2, but these pull-up resistors Ra and Rb may be provided in the operation unit 1.

Further, in the above-described embodiments, an example is given in which the motor drive unit 3 is provided separately from the control unit 2, but the motor drive unit 3 may be incorporated into the control unit 2.

Further, in the above-described embodiments, an example is given in which the power window devices are provided for a vehicle, but one or more embodiments of the present invention can also be applied to power window devices used in fields other than the vehicle.

While one or more embodiments of the invention has been described with respect to a limited number of embodiments, those skilled in the art, having benefit of this disclosure, will appreciate that other embodiments can be devised which do not depart from the scope of one or more embodiments of the invention as disclosed herein. According. the scope of the invention should be limited only by the attached claims.

1. A power window device comprising:
an operation unit comprising a first switch that is turned on by a manual opening operation for a window, a second switch that is turned on by a manual closing operation for the window, and a third switch that is turned on by an automatic opening or closing operation for the window;
a motor drive unit that drives a motor to open and close the window; and
a control unit that controls an operation of the motor drive unit based on a state of each switch of the operation unit,
wherein the operation unit comprises:
a first circuit comprising the first switch, the second switch, and a resistor; and
a second circuit comprising the third switch,
wherein in the first circuit, a series circuit of the resistor and one of the first switch and the second switch is connected between a first power supply and a ground, and the other of the first switch and the second switch is connected in parallel with the series circuit,
wherein in the second circuit, the third switch is connected between a second power supply and the ground, and
wherein the control unit is configured to:
monitor each of a first potential at one end of the first circuit on a first power supply side and a second potential at one end of the second circuit on a second power supply side;
output a manual window opening signal to the motor drive unit when the first potential is a potential at a time of the first switch being turned on, the manual window opening signal giving an instruction to open the window only during a turning on period of the first switch;
output a manual window closing signal to the motor drive unit when the first potential is a potential at a time of the second switch being turned on, the manual window closing signal giving an instruction to close the window only during a turning on period of the second switch; and
output an automatic window opening signal or an automatic window closing signal to the motor drive unit when the second potential is a potential at a time of the third switch being turned on, the automatic window opening signal giving an instruction to continuously open the window to a fully opened position, the automatic window closing signal giving an instruction to continuously close the window to a fully closed position.

2. The power window device according to claim 1,
wherein the control unit is configured to:
output the automatic window opening signal when the second potential is the potential at the time of the third switch being turned on and the first potential is the potential at the time of the first switch being turned on; and
output the automatic window closing signal when the second potential is the potential at the time of the third switch being turned on and the first potential is the potential at the time of the second switch being turned on.

3. The power window device according to claim 1,
wherein the control unit is configured to determine that submersion has occurred when the first potential is in a predetermined first submersion potential range or when the second potential is in a predetermined second submersion potential range,
wherein at a normal time when there is no submersion, the control unit
outputs the manual window opening signal when the first potential is the potential at the time of the first switch being turned on, and
outputs the manual window closing signal when the first potential is the potential at the time of the second switch being turned on, and
wherein at a time of submersion when there is submersion, the control unit
outputs the manual window opening signal when the first potential is the potential at the time of the first switch being turned on, and
does not output the manual window closing signal even when the first potential is the potential at the time of the second switch being turned on.

4. The power window device according to claim 3,
wherein the control unit is configured to:
output the automatic window opening signal when the second potential at the normal time is the potential at the time of the third switch being turned on and when the first potential at the normal time is the potential at the time of the first switch being turned on; and
output the automatic window closing signal when the second potential at the normal time is the potential at the time of the third switch being turned on and the first potential at the normal time is the potential at the time of the second switch being turned on.

5. The power window device according to claim 3,
wherein at the time of submersion, the control unit does not perform a determination of turning on of the second switch and turning on of the third switch, and determines perform only a determination of turning on of the first switch.

6. The power window device according to claim 3,
wherein with respect to the first potential at the normal time, a first submersion threshold value for determining presence or absence of submersion, a first on threshold value for determining turning on of the first switch, and a second on threshold value for determining turning on of the second switch are set in the control unit,
wherein with respect to the second potential at the normal time, a second submersion threshold value for determining presence or absence of submersion, and a third on threshold value for determining turning on of the third switch are set in the control unit,
wherein with respect to the first potential at the time of submersion, a fourth on threshold value for determining the turning on of the first switch, and a first non-submersion threshold value for determining transition from a submerged state to a non-submerged state are set in the control unit,
wherein with respect to the second potential at the time of submersion, a second non-submersion threshold value for determining the transition from the submerged state to the non-submerged state is set in the control unit,
wherein the first submersion potential range is a range between the first submersion threshold value and the first on threshold value or the second on threshold value, and
wherein the second submersion potential range is a range between the second submersion threshold value and the third on threshold value.

7. The power window device according to claim 1,
wherein the first switch is a manual opening switch that is turned on by the manual opening operation for the window,
wherein the second switch is a manual closing switch that is turned on by the manual closing operation for the window, and
wherein the third switch comprises:
an auto-opening switch that is turned on by the automatic opening operation for the window continuously performed under a state where the first switch is turned on by the manual opening operation for the window; and
an auto-closing switch that is turned on by the automatic closing operation for the window continuously performed under a state where the second switch is turned on by the manual closing operation for the window.

8. The power window device according to claim 1,
wherein the operation unit comprises a first terminal to which the one end of the first circuit is connected and a second terminal to which the one end of the second circuit is connected,
wherein the control unit comprises a third terminal connected to the first terminal by a first wiring and a fourth terminal connected to the second terminal by a second wiring,
wherein the third terminal is connected to the first power supply via a first pull-up resistor, and the fourth terminal is connected to the second power supply via a second pull-up resistor, and
wherein the control unit monitors a potential at the third terminal as the first potential and monitors a potential at the fourth terminal as the second potential.
